(19) United States
(12) Patent Application Publication
(10) Pub. No.: US 2025/0018718 A1
(43) Pub. Date: Jan. 16, 2025

(54) HEAD CLEANING METHOD AND HEAD CLEANER PERFORMING THE SAME

(71) Applicant: Samsung Display Co., Ltd., Yongin-si (KR)

(72) Inventors: HYEMIN LEE, Yongin-si (KR); JAESIK KIM, Yongin-si (KR); JUNGHAN SEO, Yongin-si (KR); KWANHYUCK YOON, Yongin-si (KR); SEUNGHO YOON, Yongin-si (KR); BYEONGJUN LEE, Yongin-si (KR); SEUNGGUN CHAE, Yongin-si (KR)

(21) Appl. No.: 18/613,128

(22) Filed: Mar. 22, 2024

(30) Foreign Application Priority Data
Jul. 12, 2023 (KR) 10-2023-0090421

(51) Int. Cl. B41J 2/165

(52) U.S. Cl. CPC B41J 2/16538; B41J 2/16544

(57) ABSTRACT

A head cleaning method includes contacting a nozzle surface of a head in which nozzle holes are defined with an absorbent on a pressurizer, starting a wiping operation at a first edge portion of the head closest to the pressurizer at a first position, and ending the wiping operation at a second edge portion of the head furthest away from the pressurizer at the first position, positioning the pressurizer at a second position to define a first angle between a first imaginary line parallel to a longitudinal direction of the head and a second imaginary line parallel to a longitudinal direction of the pressurizer, and starting the wiping operation at a third edge portion of the head closest to the pressurizer at the second position, and ending the wiping operation at a fourth edge portion of the head furthest away from the pressurizer at the second position.

This application claims priority to Korean Patent Application No. 10-2023-0090421, filed on Jul. 12, 2023, and all the benefits accruing therefrom under 35 U.S.C. § 119, the content of which in its entirety is herein incorporated by reference.

### BACKGROUND

### 1. Field

The disclosure relates to a head cleaning method, and more particularly to a cleaning method of a head included in a manufacturing device of a display device, and a head cleaner performing the head cleaning method.

### 2. Description of the Related Art

A display device may be manufactured through various processes. For example, a light-emitting layer included in the display device may be formed through an inkjet process. The light-emitting layer may be formed by discharging ink containing a light-emitting material onto a substrate. The ink may be discharged onto the substrate by an inkjet printer. The inkjet printer may include a head including a plurality of nozzles.

The inkjet process using the inkjet printer may be relatively simple by only including a one-step process of discharging ink, compared to a photolithography process, which includes various processes such as deposition, photoresist coating, exposure, development, etching, and strip processes. Accordingly, a manufacturing cost and time of the display device may be reduced.

### SUMMARY

However, periodic cleaning may be desired for the inkjet process using the inkjet printer as a nozzle clogging may occur due to ink residue.

Embodiments of the disclosure relates to a head cleaning method that may extend a lifespan of the head.

Embodiments of the disclosure relates to a head cleaner that performs the above head cleaning method.

An embodiment of a head cleaning method includes contacting a nozzle surface of a head in which a plurality of nozzle holes is defined with an absorbent disposed on a pressurizer, starting a wiping operation at a first edge portion of the head closest to the pressurizer at a first position, and ending the wiping operation at a second edge portion of the head furthest away from the pressurizer at the first position, positioning the pressurizer at a second position different from the first position to define a first angle between a first imaginary line parallel to a longitudinal direction of the head and a second imaginary line parallel to a longitudinal direction of the pressurizer, and starting the wiping operation at a third edge portion of the head closest to the pressurizer at the second position, and ending the wiping operation at a fourth edge portion of the head furthest away from the pressurizer at the second position.

In an embodiment, the head cleaning method may further include positioning the pressurizer at a third position different from the second position to define a second angle between a third imaginary line parallel to the longitudinal direction of the head and a fourth imaginary line parallel to the longitudinal direction of the pressurizer, and starting the wiping operation at a fifth edge portion of the head closest to the pressurizer at the third position, and ending the wiping operation at a sixth edge portion of the head furthest away from the pressurizer at the third position.

In an embodiment, the first angle and the second angle may be a same as each other.

In an embodiment, the first angle and the second angle may be different from each other.

In an embodiment, wherein the first angle and the second angle may be acute angles.

In an embodiment, the head cleaning method may further include replacing the absorbent each time the wiping operation ends.

In an embodiment, the replacing the absorbent may include rotating a winder disposed at opposite ends of the absorbent and winding the absorbent which wiped the nozzle surface on the winder.

In an embodiment, the pressurizer may be fixed to a stage, and a position of the pressurizer may move by rotation of the stage.

In an embodiment, a position of the pressurizer may move by rotation of the pressurizer.

In an embodiment, a position of the pressurizer may move by rotation of the head.

An embodiment of a head cleaner includes an absorbent contacting with a head including a nozzle surface in which a plurality of nozzle holes is defined, a pressurizer disposed under the absorbent, a controller which starts a wiping operation at a first edge portion of the head closest to the pressurizer at a first position, and ends the wiping operation at a second edge portion of the head furthest away from the pressurizer at the first position, positions the pressurizer at a second position different from the first position to define a first angle between a first imaginary line parallel to a longitudinal direction of the head and a second imaginary line parallel to a longitudinal direction of the pressurizer, and starts the wiping operation at a third edge portion of the head closest to the pressurizer at the second position, and ends the wiping operation at a fourth edge portion of the head furthest away from the pressurizer at the second position.

In an embodiment, the controller may further position the pressurizer at a third position different from the second position to define a second angle between a third imaginary line parallel to the longitudinal direction of the head and a fourth imaginary line parallel to the longitudinal direction of the pressurizer, and start the wiping operation at a fifth edge portion of the head closest to the pressurizer at the third position, and end the wiping operation at a sixth edge portion of the head furthest away from the pressurizer at the third position.

In an embodiment, the first angle and the second angle may be a same as each other.

In an embodiment, the first angle and the second angle may be different from each other.

In an embodiment, wherein the first angle and the second angle may be acute angles.

In an embodiment, the controller may further replace the absorbent each time the wiping operation ends.

In an embodiment, the head cleaner may further include a winder disposed at opposite ends of the absorbent. The controller may rotate the winder and wind the absorbent which wiped the nozzle surface on the winder so that the absorbent is replaced each time the wiping operation ends.

In an embodiment, the head cleaner may further include a stage, the pressurizer may be fixed to the stage, the stage may include a first rotation driver, and a position of the pressurizer may be moved as the stage is rotated by the first rotation driver.

In an embodiment, the pressurizer may further include a second rotation driver, and a position of the pressurizer may be moved as the pressurizer is rotated by the second rotation driver.

In an embodiment, the head may further include a third rotation driver, and a position of the pressurizer may be moved as the head is rotated by the third rotation driver.

As described above, in embodiments, the head cleaning method and the head cleaner performing the head cleaning method may include contacting a nozzle surface of a head in which a plurality of nozzle holes is defined with an absorbent disposed on a pressurizer, starting a wiping operation at a first edge portion of the head closest to the pressurizer at a first position, and end the wiping operation at a second edge portion of the head furthest away from the pressurizer at the first position, positioning the pressurizer at a second position different from the first position to have a first angle between a first imaginary line parallel to a longitudinal direction of the head and a second imaginary line parallel to a longitudinal direction of the pressurizer, and starting the wiping operation at a third edge portion of the head closest to the pressurizer at the second position, and end the wiping operation at a fourth edge portion of the head furthest away from the pressurizer at the second position. Accordingly, the position vulnerable to peeling of the coating film on the nozzle surface of the head may be continuously changed, and thus the lifespan of the head may be extended.

### BRIEF DESCRIPTION OF THE DRAWINGS

Illustrative, non-limiting embodiments will be more clearly understood from the following detailed description in conjunction with the accompanying drawings.

FIGS. 1, 2, 3, and 4 are a cross-sectional views of an embodiment of a head cleaner according to the disclosure.

FIGS. 5, 6, 7, 8, 9, 10, 11, 12, 13, 14, 15, 16, 17, and 18 are views illustrating a head cleaning method using the head cleaner of FIG. 1.

FIGS. 19, 20, and 21 are views illustrating an effect of the head cleaner of FIG. 1.

### DETAILED DESCRIPTION

Embodiments of the disclosure now will be described more fully hereinafter with reference to the accompanying drawings, in which various embodiments are shown. Embodiments of the disclosure may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout. Hereinafter, embodiments of the invention will be described with reference to the accompanying drawings.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein. The terminology used herein is for the purpose of describing particular embodiments

only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

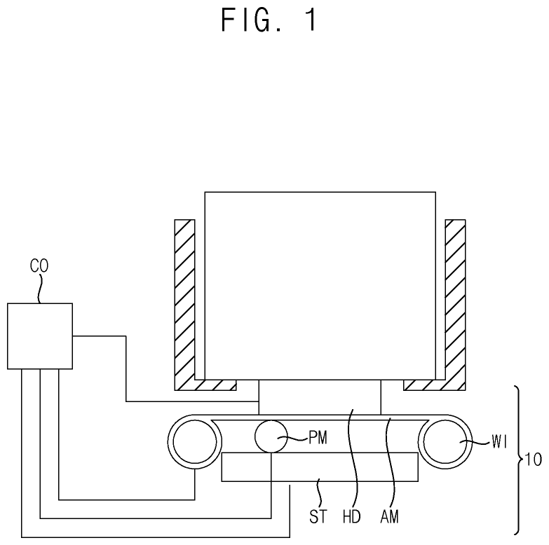

FIGS. 1, 2, 3, and 4 are a cross-sectional views of an embodiment of a head cleaner 10 according to the disclosure.

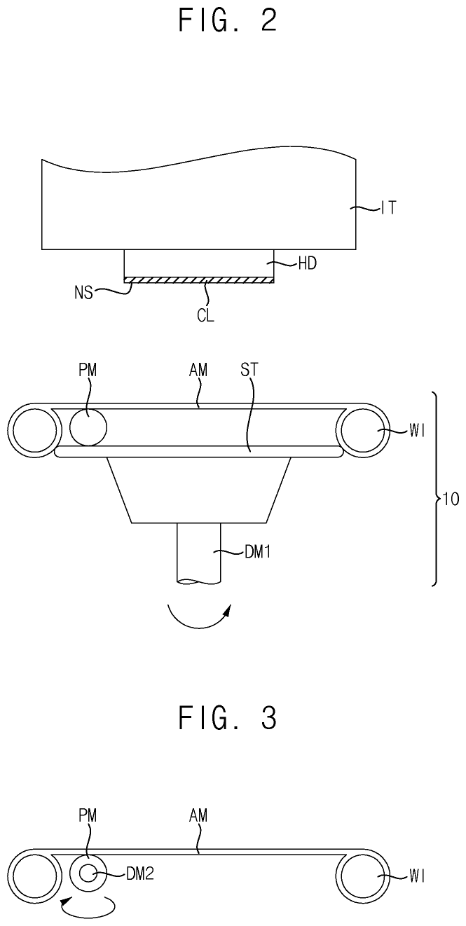

Referring to FIGS. 1 and 2, the head cleaner 10 may be applied to an inkjet process for manufacturing a display device.

When the inkjet process is continuously performed, a contamination source such as residual ink may remain on a nozzle surface of a head HD. When the contamination source is not promptly treated, the contamination source may cause a defect due to ink discharge. Accordingly, a process of cleaning the nozzle surface of the head HD may be frequently performed while performing the inkjet process.

In an embodiment, the contamination source may include inorganic ink, for example. In an embodiment, the inorganic ink may include oxide, nitride, semiconductor, or the like, for example.

In an embodiment, the oxide may include TiO₂, ZnO, SiO₂, SnO₂, WO₃, Ta₂O₃, BaTiO₃, BaZrO₃, ZrO₂, HfO₂, Al₂O₃, Y₂O₃, ZrSiO₄, Fe₂O₃, Fe₃O₄, NiO, Mg₂O, MnO, ZnMgO, ZnAlO, or the like. These may be used alone or in any combinations with each other, for example.

In an embodiment, the nitride may include InN, AlN, GaN, Si₃N₄, or the like. These may be used alone or in any combinations with each other, for example.

In an embodiment, the semiconductor may include CdTe, ZnTe, CdS, ZnSe, ZnS, Cu₂S, or the like. These may be used alone or in any combinations with each other, for example.

In an embodiment, the inorganic ink may include a quantum dot, for example. The quantum dot may be defined as a semiconductor material having nano-sized crystals. In an embodiment, the quantum dots may include group II-VI compounds, group III-V compounds, group IV-VI compounds, group IV elements, group IV compounds, and combinations thereof, for example.

In embodiments, Group II-VI compounds included in the quantum dot may be binary compounds including at least one of CdSe, CdTe, ZnS, ZnSe, ZnTe, ZnO, HgS, HgSe, HgTe, MgSe, MgS, and combinations thereof; tri-element compounds including at least one of CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and combinations thereof; and tetra-element compounds including at least one of HgZnTeS, CdZnSeS, CdZnSeTe, CdZnSTe, CdHgSeS, CdHgSeTe, CdHgSTe, HgZnSeS, HgZnSeTe, HgZnSTe, and combinations thereof.

In embodiments, Group III-V compounds included in the quantum dot may be binary compounds including at least one of GaN, GaP, GaAs, GaSb, AlN, AlP, AlAs, AlSb, InN, InP, InAs, InSb, and combinations thereof; tri-element compounds including at least one of GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and combinations thereof; and tetra-element compounds including at least one of GaAINAs, GaAINSb, GaAlPAs, GaAlPSb, GaInNP, GaInNAs, GaInNSb, GaInPAs, GaInPSb, InAINP, InAlNAs, InAlNSb, InAlPAs, InAlPSb, and combinations thereof.

In embodiments, Group IV-VI compounds included in the quantum dot may be binary compounds including at least one of SnS, SnSe, SnTe, PbS, PbSe, PbTe, and combinations thereof; tri-element compounds including at least one of SnSeS, SnSeTe, SnSTe, PbSeS, PbSeTe, PbSTe, SnPbS, SnPbSe, SnPbTe, and combinations thereof; and tetra-element compounds including at least one of SnPbSSe, SnPbSeTe, SnPbSTe, and combinations thereof.

In embodiments, Group IV elements included in the quantum dot may be Si, Ge, and combinations thereof. In addition, embodiments of Group IV compounds included in the quantum dot may be binary compounds including one of a group including SiC, SiGe, and combinations thereof.

However, the disclosure is not limited thereto. In an embodiment, the contamination source may include various substances, for example.

The head cleaner 10 in an embodiment of the disclosure may perform a blotting process while rotating at various angles. The blotting process may refer to a process of physically cleaning the head HD.

In an embodiment, the head cleaner 10 may include an absorbent AM, a pressurizer PM, a winder WI, a controller CO, a stage ST, and a driver.

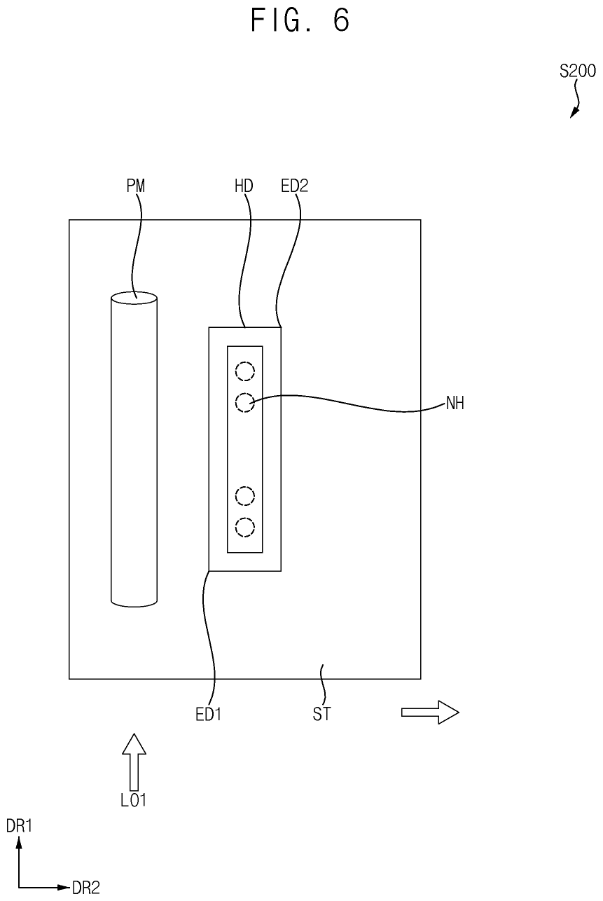

In an embodiment, the absorbent AM may contact the head HD. The head HD may include a nozzle surface NS in which a plurality of nozzle holes (e.g., a plurality of nozzle holes NH of FIG. 6) are defined.

The absorbent AM may include a material capable of absorbing ink. In an embodiment, the absorbent AM may be a fabric capable of absorbing ink well, for example. In an embodiment, the absorbent AM may include cotton fibers, hemp fibers, wool fibers, polyamide-based fibers, polyester-based fibers, polyurethane-based fibers, or the like, for example. These may be used alone or in any combinations with each other.

However, the disclosure is not limited thereto. In an embodiment, the material included in the absorbent AM and a shape of the absorbent AM may be changed in various ways, for example.

In an embodiment, the pressurizer PM may be disposed below the absorbent AM.

In an embodiment, the pressurizer PM may apply a predetermined pressure so that the absorbent AM contacts the head HD, for example. The predetermined pressure may apply tension to bring the absorbent AM into close contact with the head HD and may be of a size that does not cause damage to the head HD.

In an embodiment, the pressurizer PM may have a rod shape including or consisting of silicon, for example. However, the disclosure is not limited thereto. In an embodiment, the material included in the pressurizer PM and the shape of the pressurizer PM may be changed in various ways, for example.

In an embodiment, the winder WI may be disposed at opposite ends of the absorbent AM. In an embodiment, the winder WI may have a wire shape, for example. In an embodiment, the winder WI may include a providing portion and a recovering portion, for example. The providing portion may be provided to unwind a wound absorbent AM, and the recovering portion may be provided to wind the absorbent AM. Accordingly, the providing portion may provide a clean absorbent AM, and the recovering portion may recover the absorbent AM contaminated with the contamination source while performing the blotting process. However, the disclosure is not limited thereto. The shape of the winder WI may be changed in various ways.

In an embodiment, the controller CO may control various operations of the head cleaner 10.

The head cleaner 10 may perform the blotting process while rotating the pressurizer PM. To this end, in an embodiment, the controller CO may include a function to start a wiping operation at a first edge portion of the head HD closest to the pressurizer PM at a first position, and end the wiping operation at a second edge portion of the head HD furthest away from the pressurizer PM at the first position, a function to position the pressurizer PM at a second position different from the first position to have a first angle between a first imaginary line parallel to a longitudinal direction of the head HD and a second imaginary line parallel to a longitudinal direction of the pressurizer PM, and a function to start the wiping operation at a third edge portion of the head HD closest to the pressurizer PM at the second position, and end the wiping operation at a fourth edge portion of the head HD furthest away from the pressurizer PM at the second position.

The head cleaner 10 may perform the blotting process while rotating the pressurizer PM at various angles. To this end, in an embodiment, the controller CO may further include a function to position the pressurizer PM at a third position different from the second position to have a second angle between a third imaginary line parallel to the longitudinal direction of the head HD and a fourth imaginary line parallel to the longitudinal direction of the pressurizer PM, and a function to start the wiping operation at a fifth edge portion of the head HD closest to the pressurizer PM at the third position, and end the wiping operation at a sixth edge portion of the head HD furthest away from the pressurizer PM at the third position.

In an embodiment, the first angle and the second angle may be a same as each other. In an embodiment, the first angle and the second angle may be acute angles. In this case, the controller CO may store a predetermined angle and then perform the blotting process, and may be used to store data and maintained the coating film CL while monitoring a degree to which the coating film CL on the nozzle surface NS of the head HD is peeling off.

In another embodiment, the first angle and the second angle may be different from each other. In an embodiment, the first angle and the second angle may be acute angles. In this case, a rotation angle of the pressurizer PM may vary for each blotting process. Accordingly, a position vulnerable to peeling of the coating film CL on the nozzle surface NS of the head HD may be changed in various ways. However, the disclosure is not limited thereto. In an embodiment, the first angle and the second angle may be the right angle or the obtuse angle, for example.

In a case of a head cleaner according to a comparative example, the blotting process may be performed in a predetermined direction. In this case, the peeling of the coating film CL on the nozzle surface NS of the head HD may occur in a direction parallel to a direction in which the blotting process is performed.

However, the head cleaner 10 in an embodiment of the disclosure may perform the blotting process while rotating at various angles, so that the position vulnerable to peeling of the coating film CL on the nozzle surface NS of the head HD may be continuously changed. Accordingly, the lifespan of the head HD may be extended.

In an embodiment, the controller CO may further include a function of replacing the absorbent AM each time the wiping operation ends. In an embodiment, the function of replacing the absorbent AM may include a function of rotating the winder WI disposed at the opposite ends of the absorbent AM, and winding the absorbent AM which wiped the nozzle surface NS on the winder WI. In other words, each time the blotting process is performed, a clean absorbent AM may wipe the nozzle surface NS.

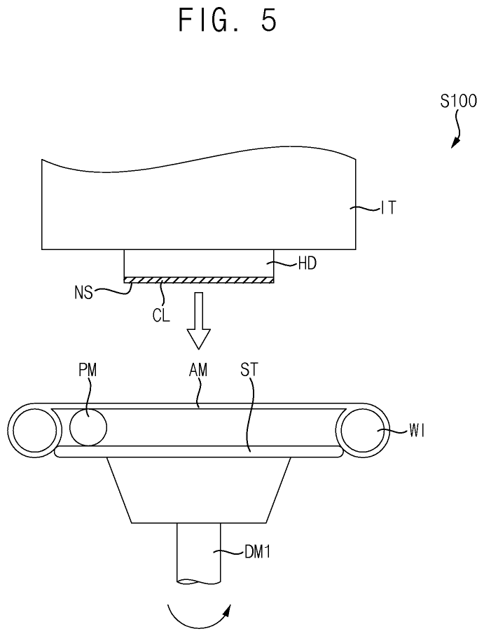

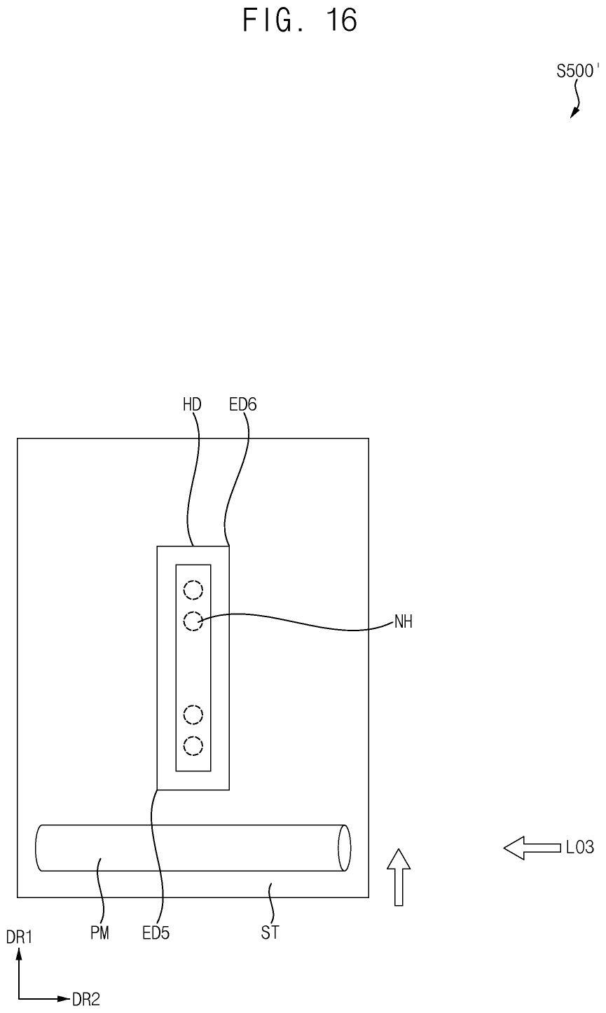

A detailed description of the blotting process will be described later with reference to FIGS. 5, 6, 7, 8, 9, 10, 11, 12, 13, 14, 15, 16, 17, and 18.

The controller CO may be implemented as a device, program, system, or the like.

In an embodiment, the pressurizer PM may be disposed on the stage ST, and the absorbent AM may be disposed on the pressurizer PM.

In an embodiment, the driver may be connected to the stage ST. In an embodiment, the stage ST may include a first rotation driver DM1, for example. In this case, the pressurizer PM may be fixed to the stage ST, and the position of the pressurizer PM may be moved (or changed) by rotation of the first rotation driver DM1.

Referring to FIG. 3, in an embodiment, the driver may be connected to the pressurizer PM. In an embodiment, the pressurizer PM may include a second rotation driver DM2, for example. In this case, the pressurizer PM may be movably connected to the stage ST, and the position of the pressurizer PM may be moved (or changed) by rotation of the second rotation driver DM2.

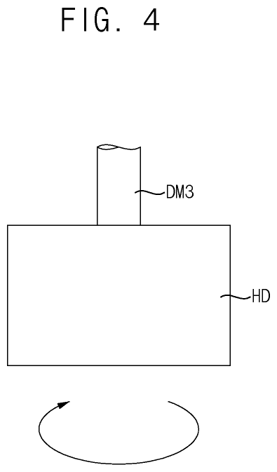

Referring to FIG. 4, in an embodiment, the driver may be connected to the head HD. In an embodiment, the head HD may include a third rotation driver DM3, for example. In this case, the position of the pressurizer PM may be moved (or changed) by rotation of the third rotation driver DM3.

However, the disclosure is not limited thereto. A configuration of the head cleaner 10 described above with reference to FIGS. 1, 2, 3, and 4 is illustrative, and the configuration may be changed, omitted, and/or added.

FIGS. 5, 6, 7, 8, 9, 10, 11, 12, 13, 14, 15, 16, 17, and 18 are views illustrating a head cleaning method using the head cleaner of FIG. 1.

Hereinafter, descriptions that overlap with those of the head cleaner 10 described above with reference to FIGS. 1, 2, 3, and 4 will be omitted or simplified.

Referring to FIG. 5, in an embodiment, the nozzle surface NS of the head HD and the absorbent AM may be brought into contact (S100).

The nozzle surface NS of the head HD may be stained with remaining ink after performing the inkjet process. The absorbent AM may physically clean the nozzle surface NS by wiping off the remaining ink.

In an embodiment, the absorbent AM may be disposed on the pressurizer PM, and the pressurizer PM may be disposed on the stage ST.

In an embodiment, the nozzle surface NS of the head HD and the absorbent AM may contact each other as the stage ST moves up and down, for example. However, the disclosure is not limited thereto. In an embodiment, the nozzle surface NS of the head HD and the absorbent AM may contact each other as the head HD moves up and down, for example.

Referring to FIGS. 5, 6, 7, and 8, in an embodiment, the wiping operation may start at a first edge portion ED1 of the head HD closest to the pressurizer PM at a first position LO1, and end the wiping operation at a second edge portion ED2 of the head HD furthest away from the pressurizer PM at the first position LO1 (S200).

The blotting process may be performed while the pressurizer PM disposed at the first position LO1 on the stage ST moves in one direction. In an embodiment, the pressurizer PM may perform the blotting process while moving linearly in a second direction DR2, for example.

However, the disclosure is not limited thereto. In an embodiment, the pressurizer PM may perform the blotting process while moving linearly in a direction opposite to the second direction DR2, for example.

The extension direction of the head HD (i.e., the direction in which the plurality of nozzle holes NH is defined) is shown to be parallel to a first direction DR1, however, the disclosure is not limited thereto.

In an embodiment, when the extension direction of the head HD is parallel to the second direction DR2, the pressurizer PM may perform the blotting process while moving linearly in the first direction DR1, for example. In an alternative embodiment, the pressurizer PM may perform the blotting process while moving linearly in a direction opposite to the first direction DR1.

In an embodiment, when the blotting process is performed in the second direction DR2, a first point PO1 vulnerable to peeling of the film may be generated in the direction parallel to the second direction DR2, for example. The first point PO1 may mean a portion where peeling of the film is likely to occur as the blotting process continues in the second direction DR2.

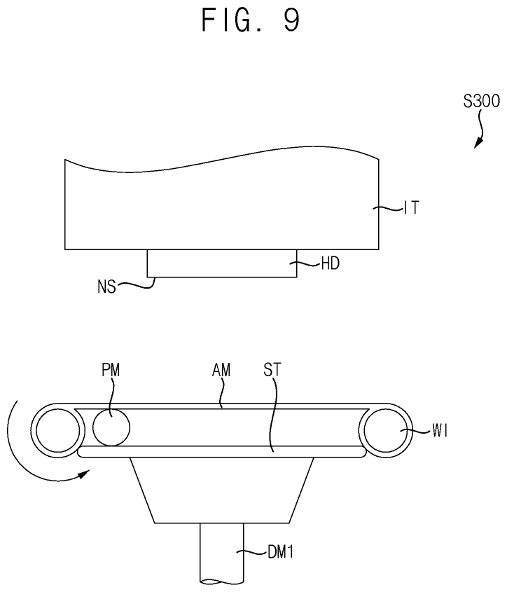

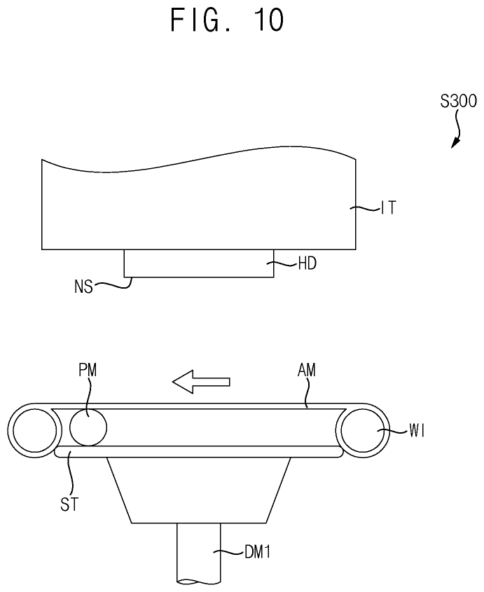

Referring to FIGS. 9 and 10, in an embodiment, after the wiping operation is completed, the absorbent AM may be replaced (S300).

In an embodiment, the winder WI disposed at opposite ends of the absorbent AM may rotate and the absorbent AM wiped the nozzle surface NS of the head HD may be replaced as the absorbent AM is wound on the winder WI.

However, the disclosure is not limited thereto. In an embodiment, any method that may replace the absorbent AM that wipes the nozzle surface NS with the clean absorbent AM whenever the wiping operation is completed may be used without limitation, for example.

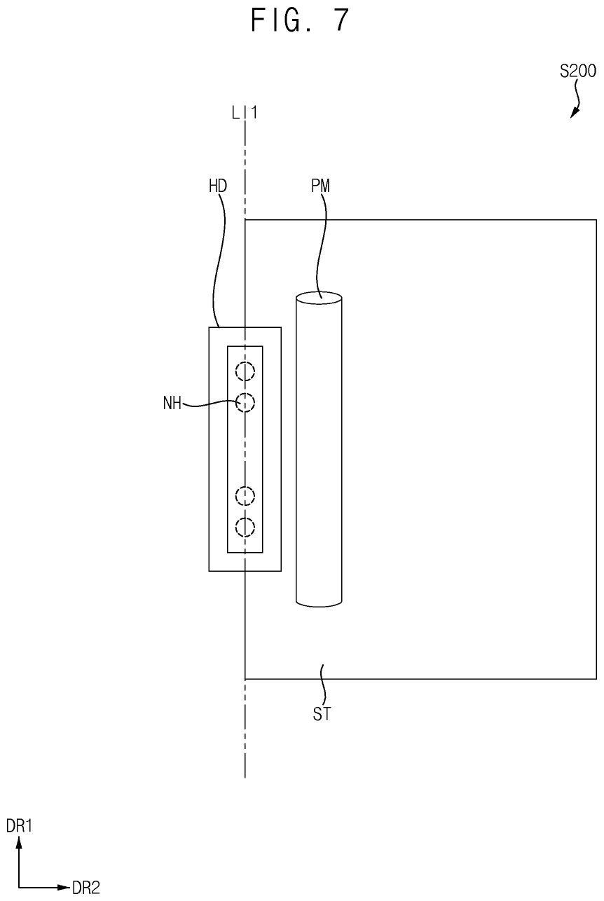

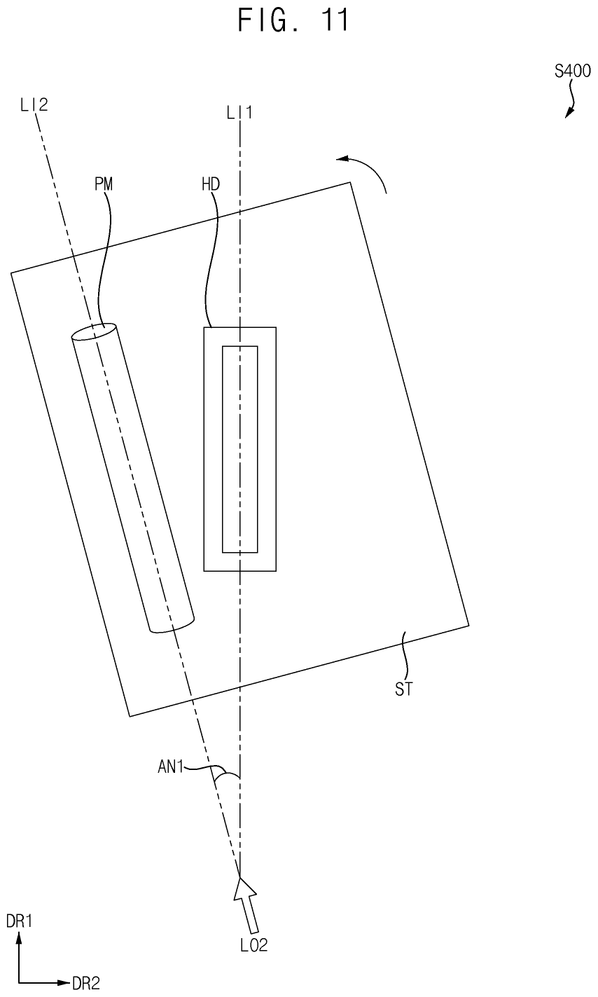

Referring to FIGS. 7 and 11, in an embodiment, the pressurizer PM may be disposed at the second position different from the first position to have the first angle between the first imaginary line and the second imaginary line (S400).

A first imaginary line LI1 may mean an imaginary line parallel to the longitudinal direction of the head HD, and a second imaginary line LI2 may mean an imaginary line parallel to the longitudinal direction of the pressurizer PM.

In an embodiment, as described above with reference to FIGS. 1 and 2, the pressurizer PM may be fixed to the stage ST, and the position of the pressurizer PM may be moved (or changed) as the stage ST rotates.

In another embodiment, as described above with reference to FIGS. 1 and 3, the position of the pressurizer PM may be moved as the pressurizer PM rotates.

In another embodiment, as described above with reference to FIGS. 1 and 4, the position of the pressurizer PM may be moved as the head HD rotates.

However, the disclosure is not limited thereto. In an embodiment, the position of the pressurizer PM may be changed in various ways, for example.

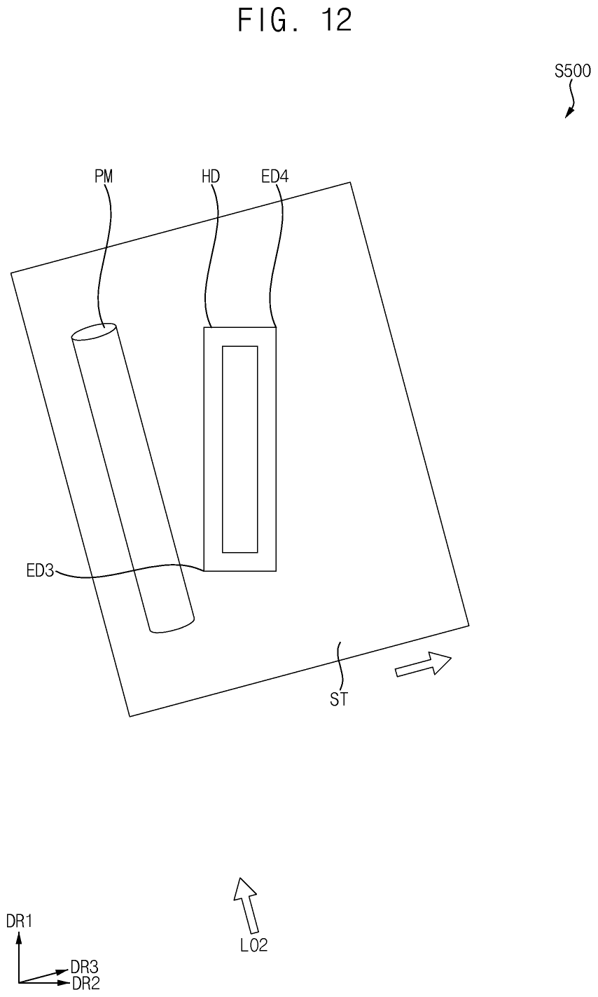

Referring to FIGS. 12, 13, and 14, the wiping operation may start at a third edge portion ED3 of the head HD closest to the pressurizer PM at the second position LO2, and end at a fourth edge portion ED4 of the head HD furthest away from the pressurizer PM at the second position LO2 (S500).

The blotting process may be performed while the pressurizer PM disposed at the second position LO2 on the stage ST moves in one direction. In an embodiment, the pressurizer PM may perform the blotting process while moving linearly in a third direction DR3, for example.

The third direction DR3 may cross each of the first direction DR1 and the second direction DR2.

However, the disclosure is not limited thereto. In an embodiment, the pressurizer PM may perform the blotting process while moving linearly in a direction opposite to the third direction DR3, for example.

In addition, the direction in which the blotting process is performed may vary depending on the extension direction of the head HD, the size of the first angle (e.g., the first angle AN1 in FIG. 11), or the like.

In an embodiment, when the blotting process is performed in the third direction DR3, a second point PO2 vulnerable to peeling of the film may be generated in the direction parallel to the third direction DR3, for example. The second point PO2 may mean a portion where peeling of the film is likely to occur as the blotting process continues in third direction DR3.

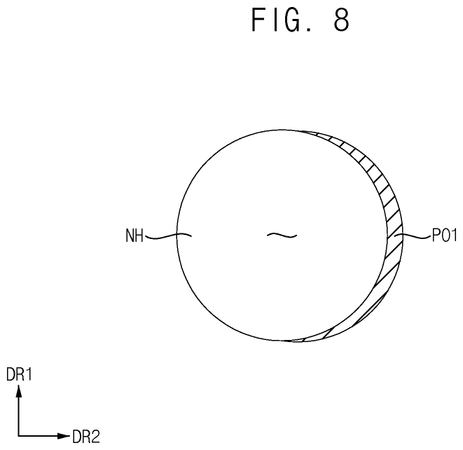

The second point PO2 vulnerable to peeling of the film when performing the blotting process in the third direction DR3 may be different from the first point (e.g., the first point PO1 of FIG. 8) vulnerable to peeling of the film when performing the blotting process in the second direction DR2. Accordingly, even when the blotting process continues, the position vulnerable to peeling of the film continues to change, thereby the lifespan of the head HD (e.g., the coating film CL of FIG. 5) may be extended.

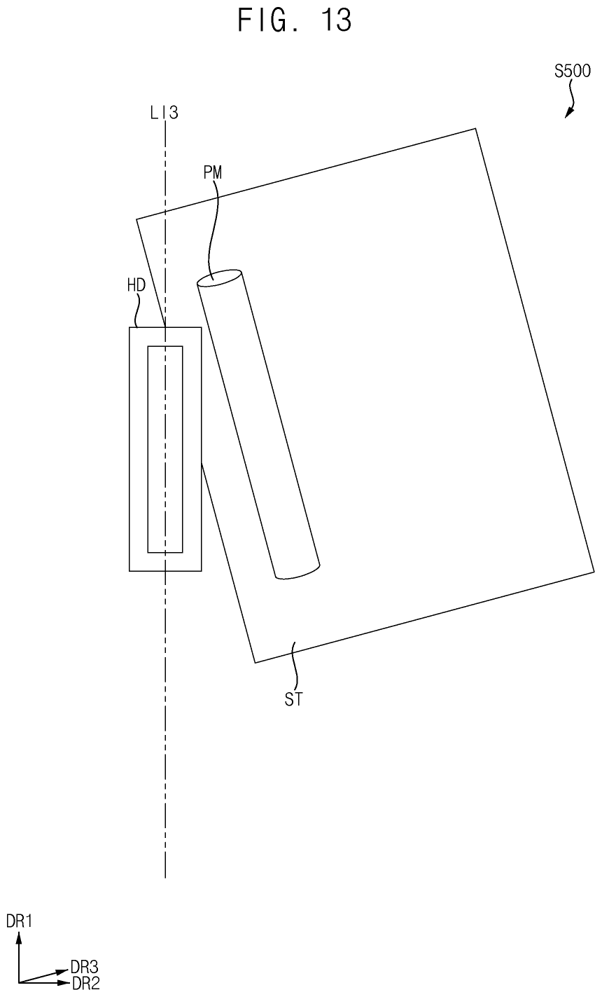

As described above with reference to FIGS. 9, 10, 11, 12, and 13, after the wiping operation is completed, the absorbent AM may be replaced (S300). Next, the blotting process may be repeated while rotating the pressurizer PM (S400, S500). Hereinafter, only the blotting process will be described with reference to FIGS. 13, 14, 15, 16, 17, and 18.

Referring to FIGS. 13, 14, and 15, in an embodiment, the pressurizer PM may be disposed at the third position different from both the first position and the second position to have a second angle AN2 between the third imaginary line LI3 and the fourth imaginary line LI4 (S400′).

The third imaginary line LI3 may mean an imaginary line parallel to the longitudinal direction of the head HD, and the fourth imaginary line LI4 may mean an imaginary line parallel to the longitudinal direction of the pressurizer PM.

In an embodiment, the first angle (e.g., the first angle AN1 of FIG. 11) and the second angle AN2 may be the same, or the first angle and the second angle AN2 may be different from each other.

In an embodiment, the first angle and the second angle AN2 may be the acute angle. However, the disclosure is not limited thereto.

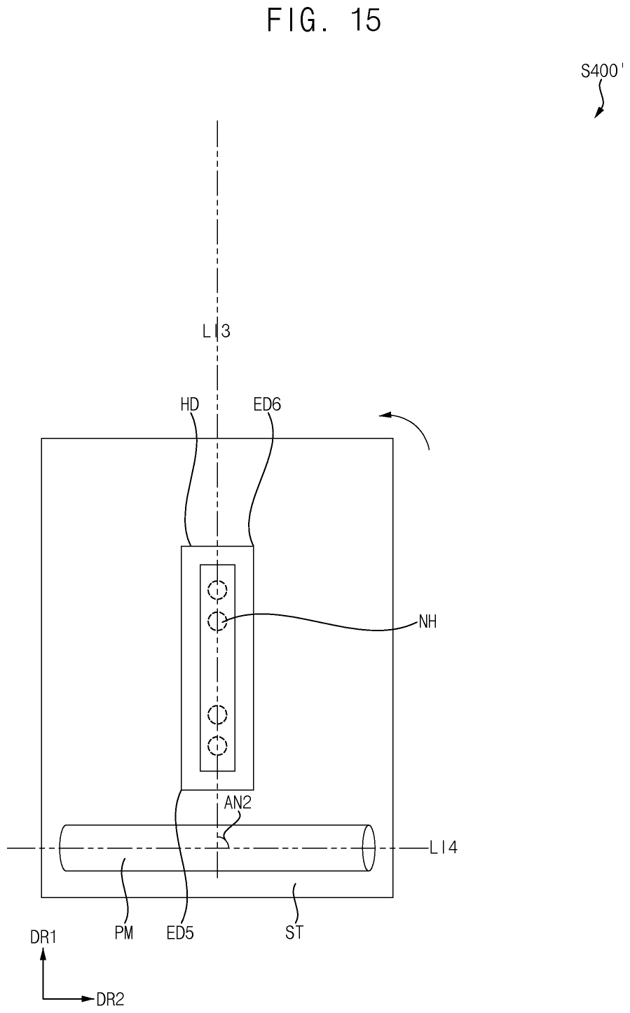

Referring to FIGS. 16, 17, and 18, the wiping operation may start at a fifth edge portion ED5 of the head HD closest to the pressurizer PM at the third position LO3, and the wiping operation may be completed at a sixth edge portion ED6 of the head HD furthest away from the pressurizer PM at the third position LO3 (S500′).

The blotting process may be performed while the pressurizer PM disposed at the third position LO3 on the stage ST moves in one direction. In an embodiment, the pressurizer PM may perform the blotting process while moving linearly in the first direction DR1, for example.

However, the disclosure is not limited thereto. In an embodiment, the pressurizer PM may perform the blotting process while moving linearly in the direction opposite to the first direction DR3, for example.

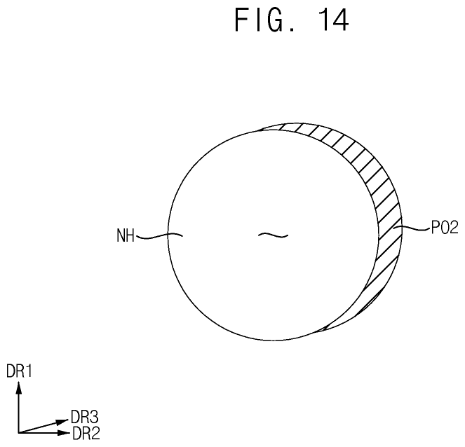

In addition, the direction in which the blotting process is performed may vary depending on the extension direction of the head HD, the size of the second angle (e.g., the second angle AN2 in FIG. 15), or the like.

In an embodiment, when the blotting process is performed in the first direction DR1, a third point PO3 vulnerable to peeling of the film may be generated in the direction parallel to the first direction DR1, for example. The third point PO3 may mean a portion where peeling of the film is likely to occur as the blotting process continues in first direction DR1.

The third point PO3 vulnerable to peeling of the film when performing the blotting process in the first direction DR1 may be different from both the first point (e.g., the first point PO1 of FIG. 8) vulnerable to peeling of the film when performing the blotting process in the second direction DR2 and the second point (e.g., the second point PO2 of FIG. 14) vulnerable to peeling of the film when performing the blotting process in the third direction DR3. Accordingly, even when the blotting process continues, the position vulnerable to peeling of the film continues to change, thereby the lifespan of the head HD (e.g., the coating film CL of FIG. 5) may be extended.

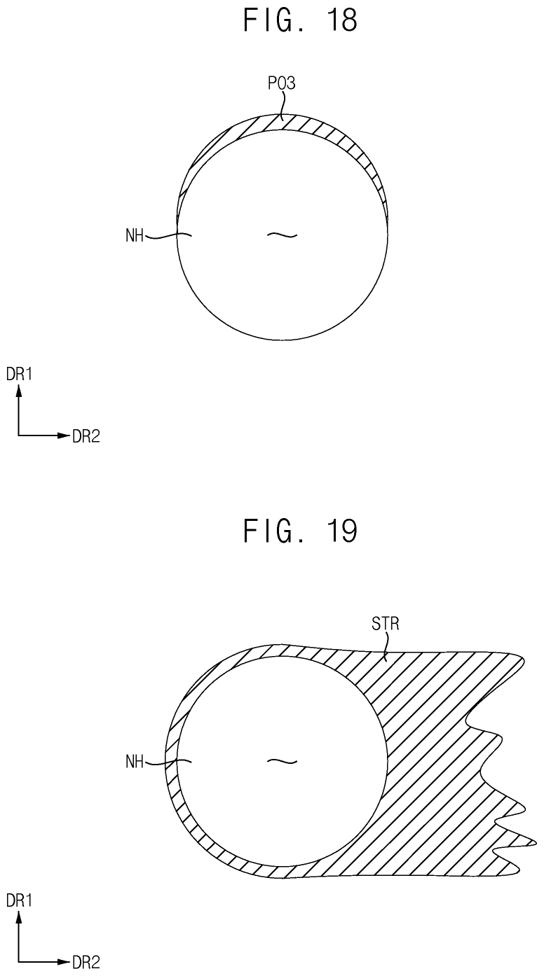

FIGS. 19, 20, and 21 are views illustrating an effect of the head cleaner of FIG. 1.

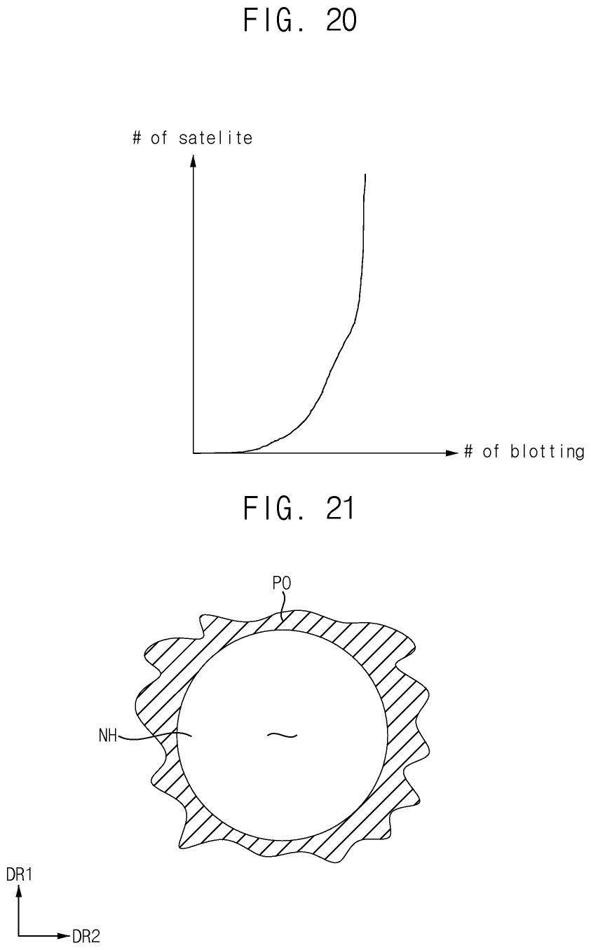

Referring to FIGS. 19 and 20, the head cleaner according to the comparative embodiment and the cleaning method using the head cleaner may continue the blotting process in one direction (e.g., the second direction DR2). In this case, a peeling of the film STR may occur in the coating film of the nozzle surface (e.g., the coating film CL of nozzle surface NS) in a parallel to the direction in which the blotting process is performed.

In an embodiment, the coating film having an opposite property compared the ink may be formed on the nozzle surface of the head that discharges the ink, for example. In an embodiment, when the ink is hydrophilic, the coating film may include or consist of a hydrophobic material, for example.

When the peeling of the film STR occurs in the head, a straightness of the ink droplet, discharging speed, or the like may be affected. Accordingly, the discharging performance of the ink may deteriorate.

As shown in FIG. 20, as the blotting process is repeated, the number of satellite droplet may increase. The satellite droplet may refer to small an ink droplet that are unintentionally generated during the inkjet process. As the number of satellite droplet increases, final printing quality may deteriorate.

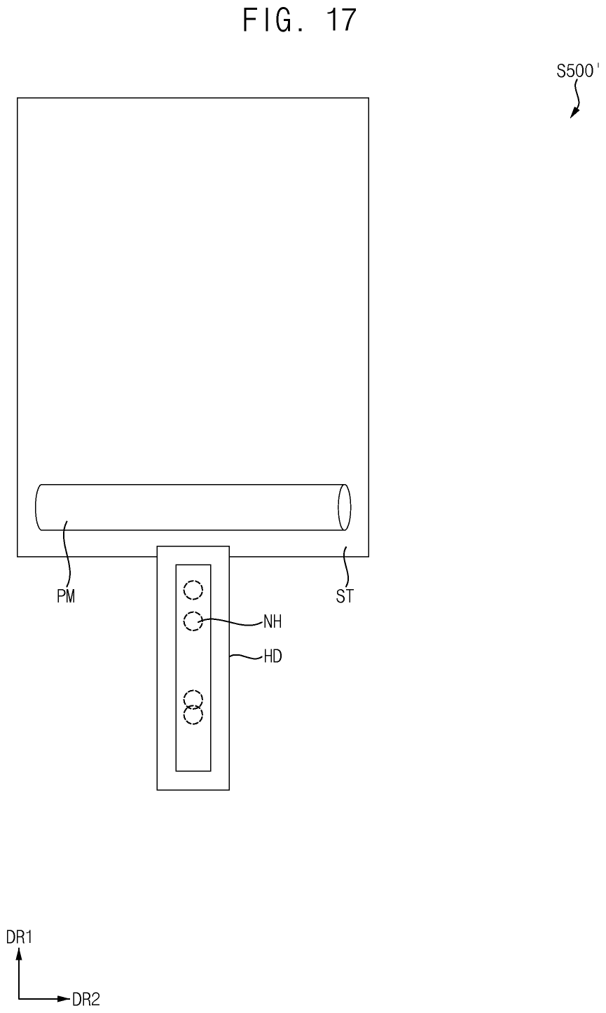

Referring to FIGS. 1, 2, and 21, the head cleaner 10 and the head cleaning method using the head cleaner 10 in an embodiment of the disclosure may perform the blotting process by rotating the pressurizer PM at various angles. Accordingly, the point PO vulnerable to peeling of the film (e.g., the first point PO1 of FIG. 8, the second point PO2 of FIG. 14, and/or the third point PO3 of FIG. 18) may be changed continuously. Accordingly, the lifespan of the head HD (e.g., the coating film CL of FIG. 5) may be extended.

Embodiments of the invention may be applied to a manufacturing process of a display device and an electronic device including the display device such as computers, notebooks, cell phones, smart phones, smart pads, portable media players (“PMPs”), personal digital assistants (“PDAs”), moving picture experts group audio layer 3 (“MP3”) players, and/or the like, for example.

Embodiments of the disclosure should not be construed as being limited to the embodiments set forth herein. Rather, these embodiments are provided so that this disclosure will be thorough and complete and will fully convey the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims. Therefore, it is to be understood that the foregoing is illustrative of various embodiments and is not to be construed as limited to the illustrative embodiments disclosed, and that modifications to the disclosed embodiments, as well as other embodiments, are intended to be included within the scope of the appended claims. Moreover, the embodiments or parts of the embodiments may be combined in whole or in part without departing from the scope of the invention.

What is claimed is:

1. A head cleaning method comprising:
contacting a nozzle surface of a head in which a plurality of nozzle holes is defined with an absorbent disposed on a pressurizer;
starting a wiping operation at a first edge portion of the head closest to the pressurizer at a first position, and ending the wiping operation at a second edge portion of the head furthest away from the pressurizer at the first position;
positioning the pressurizer at a second position different from the first position to define a first angle between a first imaginary line parallel to a longitudinal direction of the head and a second imaginary line parallel to a longitudinal direction of the pressurizer; and
starting the wiping operation at a third edge portion of the head closest to the pressurizer at the second position, and ending the wiping operation at a fourth edge portion of the head furthest away from the pressurizer at the second position.

2. The head cleaning method of claim 1, further comprising:
positioning the pressurizer at a third position different from the second position to define a second angle between a third imaginary line parallel to the longitudinal direction of the head and a fourth imaginary line parallel to the longitudinal direction of the pressurizer; and
starting the wiping operation at a fifth edge portion of the head closest to the pressurizer at the third position, and ending the wiping operation at a sixth edge portion of the head furthest away from the pressurizer at the third position.

3. The head cleaning method of claim 2, wherein the first angle and the second angle are a same as each other.

4. The head cleaning method of claim 2, wherein the first angle and the second angle are different from each other.

5. The head cleaning method of claim 2, wherein the first angle and the second angle are acute angles.

6. The head cleaning method of claim 1, further comprising:
replacing the absorbent each time the wiping operation ends.

7. The head cleaning method of claim 6, wherein the replacing the absorbent includes:
rotating a winder disposed at opposite ends of the absorbent; and
winding the absorbent which wiped the nozzle surface on the winder.

8. The head cleaning method of claim 1, wherein, the pressurizer is fixed to a stage, and a position of the pressurizer moves by rotation of the stage.

9. The head cleaning method of claim 1, wherein a position of the pressurizer moves by rotation of the pressurizer.

10. The head cleaning method of claim 1, wherein a position of the pressurizer moves by rotation of the head.

11. A head cleaner comprising:
an absorbent contacting with a head including a nozzle surface in which a plurality of nozzle holes is defined;
a pressurizer disposed under the absorbent;
a controller which:
starts a wiping operation at a first edge portion of the head closest to the pressurizer at a first position, and ends the wiping operation at a second edge portion of the head furthest away from the pressurizer at the first position, positions the pressurizer at a second position different from the first position to define a first angle between a first imaginary line parallel to a longitudinal direction of the head and a second imaginary line parallel to a longitudinal direction of the pressurizer, and
starts the wiping operation at a third edge portion of the head closest to the pressurizer at the second position, and ends the wiping operation at a fourth edge portion of the head furthest away from the pressurizer at the second position.

12. The head cleaner of claim 11, the controller further:
positions the pressurizer at a third position different from the second position to define a second angle between a third imaginary line parallel to the longitudinal direction of the head and a fourth imaginary line parallel to the longitudinal direction of the pressurizer; and
starts the wiping operation at a fifth edge portion of the head closest to the pressurizer at the third position, and ends the wiping operation at a sixth edge portion of the head furthest away from the pressurizer at the third position.

13. The head cleaner of claim 12, wherein the first angle and the second angle are a same as each other.

14. The head cleaner of claim 12, wherein the first angle and the second angle are different from each other.

15. The head cleaner of claim 12, wherein the first angle and the second angle are acute angles.

16. The head cleaner of claim 11, the controller further replaces the absorbent each time the wiping operation ends.

17. The head cleaner of claim 16, further comprising:
a winder disposed at opposite ends of the absorbent,
wherein the controller rotates the winder and winds the absorbent which wiped the nozzle surface on the winder so that the absorbent is replaced each time the wiping operation ends.

18. The head cleaner of claim 11, further comprising a stage, wherein
the pressurizer is fixed to the stage,
the stage includes a first rotation driver, and
a position of the pressurizer is moved as the stage is rotated by the first rotation driver.

19. The head cleaner of claim 11, wherein
the pressurizer further includes a second rotation driver, and
a position of the pressurizer is moved as the pressurizer is rotated by the second rotation driver.

20. The head cleaner of claim 11, wherein
the head further includes a third rotation driver, and
a position of the pressurizer is moved as the head is rotated by the third rotation driver.
